(19) United States
(12) Patent Application Publication
(10) Pub. No.: US 2009/0150721 A1
(43) Pub. Date: Jun. 11, 2009

(54) Utilizing A Potentially Unreliable Memory Module For Memory Mirroring In A Computing System

(75) Inventors: Sumeet Kochar, Apex, NC (US); Barry A. Kritt, Raleigh, NC (US); William B. Schwartz, Apex, NC (US)

Correspondence Address: IBM (RPS-BLF);c/o BIGGERS & OHANIAN, LLP, P.O. BOX 1469, AUSTIN, TX, 78767-1469, US

(73) Assignee: INTERNATIONAL BUSINESS MACHINES CORPORATION, ARMONK, NY (US)

(21) Appl. No.: 11/953,309

(22) Filed: Dec. 10, 2007

(51) Int. Cl. G06F 11/14

(52) U.S. Cl. 714/6; 714/E11.113

(57) ABSTRACT

Methods, apparatus, and products are disclosed for utilizing a potentially unreliable memory module for memory mirroring in a computing system, the computing system including at least two memory modules, that includes: retrieving error information from an error log stored in non-volatile memory, the error information describing an occurrence of a correctable memory error on one of the memory modules; determining whether a memory mirroring mode is enabled for the computing system, the memory mirroring mode specifying that memory contents are mirrored on the two memory modules; and utilizing, in dependence upon the error information, the memory module on which the correctable memory error occurred to mirror the memory contents if the memory mirroring mode is enabled.

### BACKGROUND OF THE INVENTION

1. Field of the Invention

The field of the invention is data processing, or, more specifically, methods, apparatus, and products for utilizing a potentially unreliable memory module for memory mirroring in a computing system.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

In order to deliver powerful computing resources, computer architects must design robust computing systems capable of tolerating and recovering from equipment errors. To build error-tolerant computing systems, computer architects often use memory mirroring technology. Memory mirroring technology employs the use of two redundant memory modules separately storing the same memory contents. When memory mirroring is enabled in a computing system, an operating system only has access to one-half of the totals storage space provided by the redundant memory modules. For example, if two four Gigabyte memory modules are installed in the computing system for a total of eight Gigabytes, the operating system only has access to four Gigabytes, and the remaining four Gigabytes are utilized to provide memory mirroring.

To access the redundant memory modules, the computing system includes a specialized memory controller. When instructed to write data to the mirrored memory modules, the specialized memory controller writes the data to both of the memory modules. When instructed to read data from the mirrored memory modules, the specialized memory controller, the specialized memory controller reads data from both memory modules and ensures that the Error Correcting Code (‘ECC’) bits from the primary memory module indicate that the correct data is read. If the ECC bits do not indicate that the correct data read, the data from the secondary memory module is used provided the ECC bits for the secondary memory module indicate that the correct data is read.

The drawback to using memory mirroring technology, however, is that memory mirroring requires that twice the amount of memory be installed in the computing system than the amount of memory that needs to be provided to the operating system. As mentioned above, memory mirroring also requires that the computing system include a specialized memory controller. Installing twice the amount of computer memory and a specialized memory controller substantially increases the overall cost of the computing system.

### SUMMARY OF THE INVENTION

Methods, apparatus, and products are disclosed for utilizing a potentially unreliable memory module for memory mirroring in a computing system, the computing system including at least two memory modules, that includes: retrieving error information from an error log stored in non-volatile memory, the error information describing an occurrence of a correctable memory error on one of the memory modules; determining whether a memory mirroring mode is enabled for the computing system, the memory mirroring mode specifying that memory contents are mirrored on the two memory modules; and utilizing, in dependence upon the error information, the memory module on which the correctable memory error occurred to mirror the memory contents if the memory mirroring mode is enabled.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of an exemplary computing system for utilizing a potentially unreliable memory module for memory mirroring in a computing system according to embodiments of the present invention.

FIG. 2 sets forth a flow chart illustrating an exemplary method of utilizing a potentially unreliable memory module for memory mirroring in a computing system according to embodiments of the present invention.

FIG. 3 sets forth a flow chart illustrating a further exemplary method of utilizing a potentially unreliable memory module for memory mirroring in a computing system according to embodiments of the present invention.

FIG. 4 sets forth a flow chart illustrating a further exemplary method of utilizing a potentially unreliable memory module for memory mirroring in a computing system according to embodiments of the present invention.

### DETAILED DESCRIPTION OF EXEMPLARY EMBODIMENTS

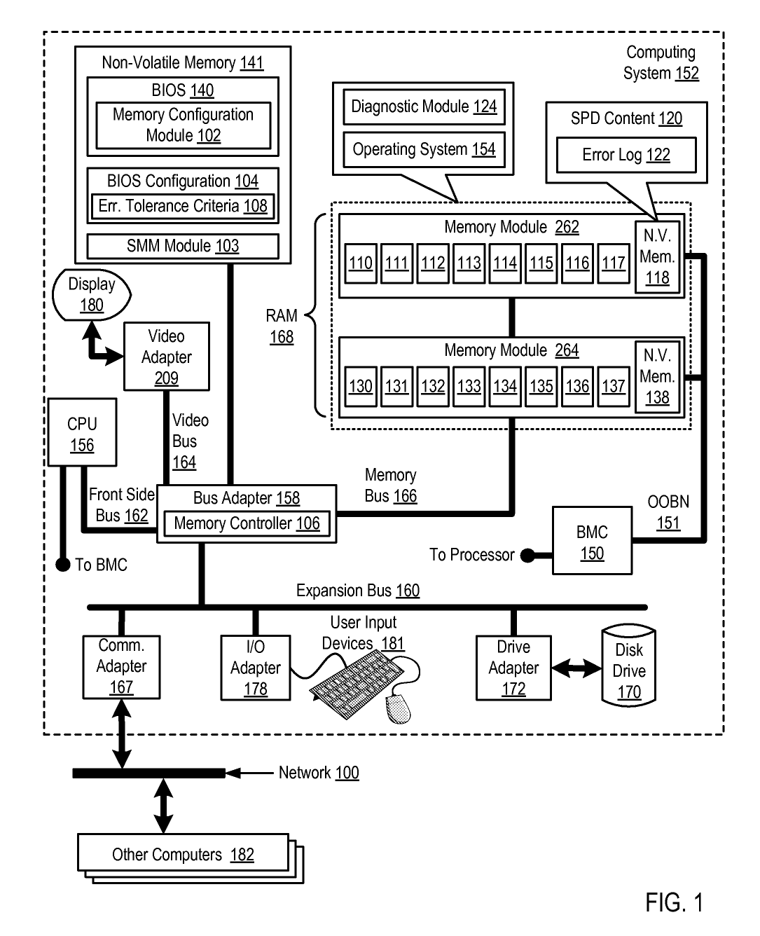

Exemplary methods, apparatus, and products for utilizing a potentially unreliable memory module for memory mirroring in a computing system in accordance with the present invention are described with reference to the accompanying drawings, beginning with FIG. 1. FIG. 1 sets forth a block diagram of automated computing machinery comprising an exemplary computing system (152) useful in utilizing a potentially unreliable memory module for memory mirroring in a computing system according to embodiments of the present invention. A potentially unreliable memory module is a memory module for which an occurrence of a correctable memory error has been detected. The correctable error memory error may or may not be due to unreliable memory because the error could also have been caused by errors in the memory bus, the memory controller, or environmental issues such as power spikes, thermal conditions, or alpha particle interference. Because memory modules having a previous history of correctable errors may often be obtained at a lower cost than memory modules without a previous history of errors, such potentially unreliable memory modules may be utilized for memory mirroring while lowering the overall cost of providing memory mirroring in a computing system. At the same time, due to the inherent redundancy available using memory mirroring technology, utilizing a potentially unreliable memory module for memory mirroring in a computing system may be acceptable for many users.

Memory errors are correctable when such errors are detectable and reversible, that is the original, error-free data corrupted by the memory error is reconstructable. Memory errors may be detected and reversed using error detection algorithms and error correction algorithms. Error detection algorithms may include, for example, repetition algorithms, parity algorithms, polarity algorithms, cyclic redundancy checking algorithms, checksum algorithms, hamming distance based checking algorithms, and so on. Error correction algorithms may include, for example, automatic repeat request algorithms, error-correcting code algorithms, and error-correcting memory algorithms, and so on.

For an example of a correctable memory error, consider a single-bit memory error. A single-bit memory error is an error in a group of bits associated with a memory location in which only one of the bits has an errant value. Such single-bit memory errors may be transient errors that occur due to alpha particles or cosmic rays or permanent errors that occur due to physical defects in the memory module. Regardless of whether the single-bit errors are permanent or transient, the single-bit errors may be detected and corrected when enough ECC bits are available for error correction. In addition, other multiple-bit errors are also generally correctable when a sufficient number of ECC bits are available to detect and correct the errors. The number of ECC bits needed to detect and correct an error generally increases with the number of bit-errors in the error.

The computing system (152) of FIG. 1 includes at least one computer processor (156) or ‘CPU’ as well as random access memory (168) (‘RAM’) which is connected through a high speed memory bus (166) and bus adapter (158) to processor (156) and to other components of the computing system (152). In this example, the RAM (168) is implemented in two memory modules (262, 264). Each memory module is a group of RAM integrated circuits and non-volatile memory mounted on a printed circuit board. In the example of FIG. 1, the memory module (262) includes RAM integrated circuits (110-117) and non-volatile memory (118), while the memory module (264) includes RAM integrated circuits (130-137) and non-volatile memory (138). The memory modules (262, 264) of FIG. 1 may be implemented as a single in-line memory modules (‘SIMM’), dual in-line memory modules (‘DIMM’), and in other form factors as will occur to those of skill in the art.

The computing system (152) of FIG. 1 includes non-volatile memory (141). In the example of FIG. 1, non-volatile memory (141) stores Basic Input/Output System (‘BIOS’) (140), BIOS configuration (104), and system management mode (‘SMM’) module (103). BIOS (140) is firmware that initializes and tests the hardware components of the computer as well as loads, executes, and passes control of computer hardware components over to an operating system. In addition, BIOS remains in use after the operating system loads to provide the operating system low-level access to certain computer hardware devices. BIOS configuration (104) is a table that stores configuration information regarding the computing system (152) utilized by the BIOS (140) load the operating system and perform low-level hardware access. The SMM module (103) is firmware that instructs the processor (156) to perform certain low-level hardware functions such as, for example, power management operations, hardware error handling, and so on. The processor (156) executes the SMM module (103) upon detecting an interrupt via a designated pin of the processor (156) or via software messages to the processor (156). The interrupt may be triggered by a hardware event or by system software writing to a designated I/O address. In the example of FIG. 1, the non-volatile memory (141) may be implemented using Electrically Erasable Programmable Read-Only Memory (‘EEPROM’) or any other non-volatile memory as will occur to those of skill in the art.

The BIOS (140) of FIG. 1 includes a memory configuration module (102). The memory configuration module (102) operates generally for utilizing a potentially unreliable memory module for memory mirroring in a computing system according to embodiments of the present invention. The memory configuration module (102) of FIG. 1 may operate generally for utilizing a potentially unreliable memory module for memory mirroring in a computing system according to embodiments of the present invention by: retrieving error information from an error log (122) stored in non-volatile memory (118), the error information describing an occurrence of a correctable memory error on memory module (262); determining whether a memory mirroring mode is enabled for the computing system (152), the memory mirroring mode specifying that memory contents are mirrored on the two memory modules (262, 264); and utilizing, in dependence upon the error information, the memory module (262) on which the correctable memory error occurred to mirror the memory contents if the memory mirroring mode is enabled.

The memory configuration module (102) of FIG. 1 may utilize the memory module (262) on which the correctable memory error occurred to mirror the memory contents by utilizing the memory module (262) on which the correctable memory error occurred as a primary memory module on which the memory contents are mirrored and utilizing the other memory module (264) as a secondary memory module on which the memory contents are mirrored. The primary memory module is the memory module storing the memory contents from which the memory controller (106) first attempts to satisfy read requests. The secondary memory module is the memory module storing the memory contents from which the memory controller (106) attempts to satisfy read requests when the memory contents retrieved from the primary memory module contain an uncorrectable error. The memory configuration module (102) of FIG. 1 may utilize the memory module (262) on which the correctable memory error occurred as a primary memory module on which the memory contents are mirrored by configuring the memory controller (106) to retrieving memory contents from the memory module (264) only when the memory contents from the memory module (262) contain uncorrectable errors or when the correctable errors exceeds a predetermined threshold.

Readers will note that utilizing the memory module (262) on which the correctable memory error occurred as a primary memory module is for explanation only and not for limitation. Utilizing the memory module (262) as the primary memory module, however, may provide more current information on error status and frequency for memory module (262). In some other embodiments, the memory configuration module (102) of FIG. 1 may utilize the memory module on which the correctable memory error occurred to mirror the memory contents by utilizing the memory module on which the correctable memory error occurred as a secondary memory module on which the memory contents are mirrored and utilizing the other memory module as a primary memory module on which the memory contents are mirrored. Utilizing the memory module (262) as the secondary memory module may provide better performance because the process of correcting the correctable memory errors may require the memory controller to add delay cycles to the memory subsystem.

In some embodiments, the memory configuration module (102) of FIG. 1 may also operate generally for utilizing a potentially unreliable memory module for memory mirroring in a computing system according to embodiments of the present invention by determining whether the correctable memory error satisfies error tolerance criteria (108). Error tolerance criteria (108) represent rules for determining whether a particular memory module on which errors have occurred should be used for memory mirroring in the computing system (152). For example, error tolerance criteria may specify that a memory module on which uncorrectable errors have occurred should not be used. For further example, error tolerance criteria may specify that a memory module on which more than ten correctable errors have occurred in over a twenty-four hour period should not be used. When determining whether the correctable memory error satisfies error tolerance criteria (108), the memory configuration module (102) of FIG. 1 may utilize the memory module (262) on which the correctable memory error occurred to mirror the memory contents if the correctable memory error satisfies error tolerance criteria (108).

In the example of FIG. 1, the error log (122) is included in Serial Presence Detect (‘SPD’) content (120), which is stored in non-volatile memory (118) of memory module (262). The SPD content (120) is information about the memory module (262) that is stored in 256 byes of the module's non-volatile memory (118) according to the Joint Electron Device Engineering Council (‘JEDEC’) Standard No. 21-C. According to JEDEC Standard No. 21-C, the first 128 bytes of the SPD content (120) includes information such as, for example, memory type, memory size, manufacturing information, and so on. The last 128 bytes of the SPD content area is available for custom uses such as storing the error log (122) useful in utilizing a potentially unreliable memory module for memory mirroring in a computing system according to embodiments of the present invention. For further explanation, consider the following exemplary error log format for storing error information:

| LOCATION | |
|---|---|
| (in bytes) | DESCRIPTION |
| | ERROR LOG HEADER - ERROR INFORMATION |
| | SUMMARY AND POWER ON HOURS |
| 128-130 | Error Information Version (‘$E1’ - indicates bytes |
| | 128-256 are used for storing error log version 1.0) |
| 131-134 | Cumulative Power On hours |
| 135-137 | Date and time of last Power On |
| 138-141 | Cumulative Power On hours of |
| | last failure (if applicable) |
| 142-144 | Date and time of last failure (if applicable) |
| 145-146 | Number of failures |
| 147 | Failure frequency rate |
| | ERROR INFORMATION FOR MOST |
| | RECENT ERROR (11 BYTES) |
| 148-150 | Date and time of failure |
| 151-152 | Failing system identifier and |
| | identifier for reporting entity |
| 153 | Failure type |
| 154 | Failing chip select and failing bank |
| 155-156 | Failing row address |
| 157-158 | Failing column address |
| | ERROR INFO. FOR SECOND MOST |
| | RECENT ERROR (11 BYTES) |
| . . . | . . . |
| | ERROR INFO. FOR THIRD MOST |
| | RECENT ERROR (11 BYTES) |
| . . . | . . . |

Readers will note that the exemplary error log format above is for explanation only and not for limitation. Other exemplary error log formats may also be useful in storing error information in the SPD content stored in a memory module's non-volatile memory. Readers will further note that storing the error log in SPD content stored in a memory module's non-volatile memory is also for explanation only and not for limitation. In fact, the error log may be stored in other non-volatile memory as will occur to those of skill in the art, including the non-volatile memory mounted to the motherboard of the computing system (152).

The exemplary computing system (152) of FIG. 1 includes several components (103, 124) that may be useful in utilizing a potentially unreliable memory module for memory mirroring in a computing system according to embodiments of the present invention by detecting the occurrence of memory errors on one of the memory modules (262, 264) and storing error information for the memory error occurrences in an error log in non-volatile memory. Such components include the SMM module (103) and a diagnostic module (124). In addition, readers will appreciate that the memory supplier for the memory modules (262, 264) may also detect the occurrence of the memory errors on the memory modules and store the error information for the memory error occurrences in the error log in non-volatile memory of the memory modules.

The SMM module (103) detects occurrences of errors in the memory modules (262, 264) and stores error information in non-volatile memory of the memory modules (262) using a Baseboard Management Controller (‘BMC’) (150). The BMC (150) of FIG. 1 is a specialized microcontroller embedded on the motherboard of the computing system (152) that manages the interface between SMM module (103) and platform hardware. The BMC (150) accesses the non-volatile memory (118, 138) of each memory module (262, 264) through an out-of-band network (‘OOBN’) (151). The OOBN (151) of FIG. 1 may be implemented as an I²C bus, for example, a multi-master serial computer bus invented by Philips that is used to attach low-speed peripherals to a motherboard or an embedded system. I²C is a simple, low-bandwidth, short-distance protocol that employs only two bidirectional open-drain lines, Serial Data (SDA) and Serial Clock (SCL), pulled up with resistors. Through the OOBN (151), the BMC (150) stores error information in non-volatile memory (118, 138) of the memory modules (262, 264). Although the exemplary computer (152) may utilize the I²C protocol, readers will note this is for explanation and not for limitation. In addition to the I²C protocol, the OOBN (151) may be implemented using other technologies as will occur to those of ordinary skill in the art, including for example, technologies described in the Intelligent Platform Management Interface (‘IPMI’) specification, the System Management Bus (‘SMBus’) specification, the Joint Test Action Group (‘JTAG’) specification, and so on.

The diagnostic module (124) is stored in RAM (168) along with operating system (154). The diagnostic module (124) is computer software that allows a user to detect errors in the memory modules (262, 264) and store the error information in an error log in non-volatile memory. In addition, the diagnostic module (124) allows a user to administer error information and provides analytic tools to the user for analyzing the error information stored in the non-volatile memory. For example, using the diagnostic module (124) the user may clear the error information stored in the non-volatile memory, forecast how previous errors may affect a computing system if those errors occur again, determine the most recent error, and so on. Operating systems that may be improved for utilizing a potentially unreliable memory module for memory mirroring in a computing system according to embodiments of the present invention include UNIX™, Linux™, Microsoft XP™, AIX™, IBM's i5/OS™, and others as will occur to those of skill in the art. The operating system (154) and the diagnostic module (124) in the example of FIG. 1 are shown in RAM (168), but many components of such software typically are stored in non-volatile storage also, such as, for example, on a disk drive (170).

In the example of FIG. 1, the bus adapter (158) includes a memory controller (106) capable of mirroring memory contents on memory modules (262, 264). As mentioned above, when the memory controller (106) receives a memory write instruction, the memory controller (106) writes the same data to both memory module (262) and memory module (264). Upon receiving a read instruction, the memory controller (106) reads data from both memory modules (262, 264) and ensures that the ECC bits from the primary memory module (262) indicate that the correct data is read. If the ECC bits do not indicate that the correct data read, the data from the secondary memory module (264) is used provided the ECC bits for the secondary memory module (264) indicate that the correct data is read from the secondary memory module (264). Again, readers will note that utilizing memory module (262) as the primary memory module is for explanation only and not for limitation. In some other embodiments, memory module (264) may be utilized as the primary memory module.

The computing system (152) of FIG. 1 includes disk drive adapter (172) coupled through expansion bus (160) and bus adapter (158) to processor (156) and other components of the computing system (152). Disk drive adapter (172) connects non-volatile data storage to the computing system (152) in the form of disk drive (170). Disk drive adapters useful in computers for utilizing a potentially unreliable memory module for memory mirroring in a computing system according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computing system (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example computing system (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary computing system (152) of FIG. 1 includes a communications adapter (167) for data communications with other computers (182) and for data communications with a data communications network (100). Such data communications may be carried out serially through RS-232 connections, through external buses such as a Universal Serial Bus (‘USB’), through data communications data communications networks such as IP data communications networks, and in other ways as will occur to those of skill in the art. Communications adapters implement the hardware level of data communications through which one computer sends data communications to another computer, directly or through a data communications network. Examples of communications adapters useful for utilizing a potentially unreliable memory module for memory mirroring in a computing system according to embodiments of the present invention include modems for wired dial-up communications, Ethernet (IEEE 802.3) adapters for wired data communications network communications, and 802.11 adapters for wireless data communications network communications.

The arrangement components making up the exemplary computer (152) illustrated in FIG. 1 are for explanation, not for limitation. Computers useful according to various embodiments of the present invention may include additional components, data communications buses, or other computer architectures, not shown in FIG. 1, as will occur to those of skill in the art. In such a manner, various embodiments of the present invention may be implemented on a variety of hardware platforms in addition to those illustrated in FIG. 1.

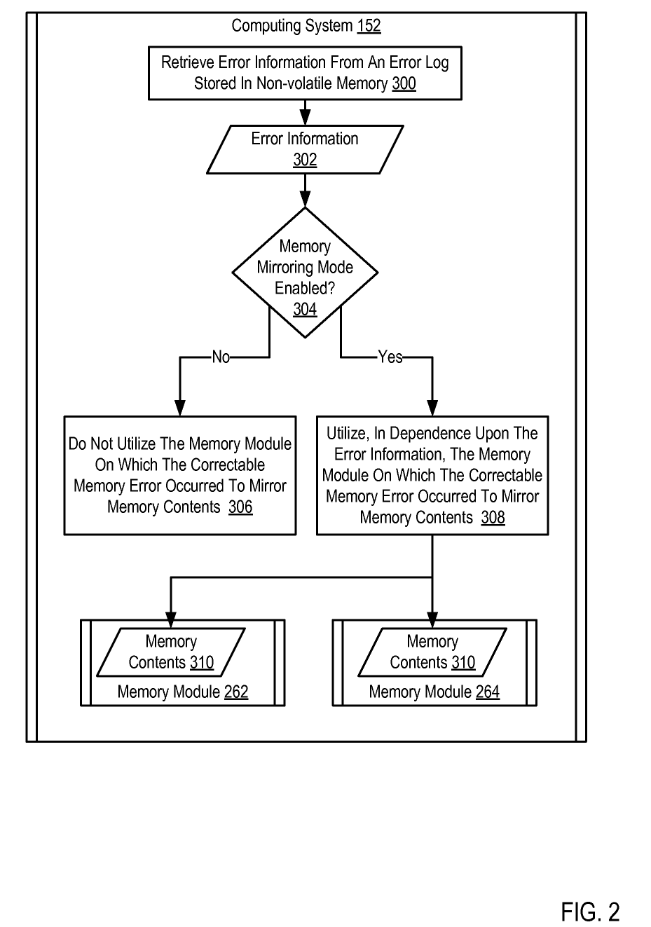

For further explanation, FIG. 2 sets forth a flow chart illustrating an exemplary method for utilizing a potentially unreliable memory module for memory mirroring in a computing system according to embodiments of the present invention. In the example of FIG. 2, the computing system (152) includes at least two memory modules (262, 264).

The method of FIG. 2 includes retrieving (300) error information (302) from an error log stored in non-volatile memory. The error information (302) of FIG. 2 describes an occurrence of a correctable memory error on one of the memory modules (262, 264). The non-volatile memory containing the error log may be configured on the memory module that experienced the error occurrence, configured on the motherboard of the computing system (152), or configured in any other place as will occur to those of skill in the art. When the non-volatile memory is configured on the memory module that experienced the error occurrence, the error log may be stored as part of the SPD contents contained on the memory module according to JEDEC Standard No. 21-C as described above. In such an embodiment, retrieving (300) error information (302) from an error log stored in non-volatile memory according to the method of FIG. 2 may be carried out by reading the error information (302) from the last 128 bytes of SPD content stored on the memory module. When the non-volatile memory is configured on the motherboard of the computing system (152), retrieving (300) error information (302) from an error log stored in non-volatile memory according to the method of FIG. 2 may be carried out by looking up the error log location in BIOS configuration and reading the error information (302) from the error log.

The method of FIG. 2 also includes determining (304) whether a memory mirroring mode is enabled for the computing system (152). The memory mirroring mode specifies that the computing system (152) should mirror memory contents (310) on the two memory modules (262, 264). Determining (304) whether a memory mirroring mode is enabled for the computing system (152) according to the method of FIG. 2 may be carried out by identifying whether the physical configurations of the two memory modules (262, 264) support memory mirroring and identifying whether a system administrator has specified in BIOS configuration that memory mirroring is to be utilized when the physical configurations of the two memory modules (262, 264) support memory mirroring. If the physical configurations of the two memory modules (262, 264) support memory mirroring and if a system administrator has specified in BIOS configuration that memory mirroring is to be utilized when the physical configurations of the two memory modules (262, 264) support memory mirroring, then memory mirroring mode is enabled for the computing system (152). Memory mirroring mode is not enabled for the computing system (152), however, if the physical configurations of the two memory modules (262, 264) do not support memory mirroring or if a system administrator has specified in the BIOS configuration not to use memory mirroring even when the physical configurations of the two memory modules (262, 264) support memory mirroring.

Identifying whether the physical configurations of the two memory modules (262, 264) support memory mirroring may be carried out by determining whether the physical characteristics of each memory module (262, 264) match. Such physical characteristics may include, for example, operating frequency, storage size, memory type, and so on. Identifying whether the physical configurations of the two memory modules (262, 264) support memory mirroring may also be carried out by determining whether the respective sockets into which the memory modules (262, 264) are installed are connected to the memory controller in a manner that permits memory mirroring. If the physical characteristics of each memory module (262, 264) match and the respective sockets into which the memory modules (262, 264) are installed are connected to the memory controller in a manner that permits memory mirroring, then the physical configurations of the two memory modules (262, 264) support memory mirroring.

Identifying whether a system administrator has specified in BIOS configuration that memory mirroring is to be utilized when the physical configurations of the two memory modules (262, 264) support memory mirroring may be carried out by reading a field value in the BIOS configuration that is stored in non-volatile memory of the computing system (152). When the field is implemented as a binary field, a system administrator may set the binary field value to TRUE to indicate that memory mirroring is to be utilized when the physical configurations of the two memory modules (262, 264) support memory mirroring. The system administrator may set the binary field value to FALSE to indicate that memory mirroring is not to be utilized even when the physical configurations of the two memory modules (262, 264) support memory mirroring. The system administrator may change the value of the binary field through a user interface provided by the BIOS.

The method of FIG. 2 includes not utilizing (306) the memory module on which the correctable memory error occurred if the memory mirroring mode is not enabled. Not utilizing (306) the memory module on which the correctable memory error occurred according to the method of FIG. 2 may be carried out by configuring a memory controller in the computing system (152) to not utilize memory mirroring and to not enable or utilize the memory module on which the correctable error occurred. The memory controller may be configured to not utilize memory mirroring by writing data to the configuration registers for the memory controller that instruct the memory controller to not utilize memory mirroring.

The method of FIG. 2 includes utilizing (308), in dependence upon the error information (302), the memory module on which the correctable memory error occurred to mirror the memory contents (310) if the memory mirroring mode is enabled. Utilizing (308) the memory module on which the correctable memory error occurred to mirror the memory contents (310) according to the method of FIG. 2 may be carried out by utilizing the memory module on which the correctable memory error occurred as a primary memory module on which the memory contents (310) are mirrored and utilizing the other memory module as a secondary memory module on which the memory contents (310) are mirrored. Utilizing the memory module on which the correctable memory error occurred as a primary memory module and utilizing the other memory module as a secondary memory module may be carried out by writing data to the configuration registers for the memory controller that instruct the memory controller to utilize the memory module on which the correctable memory error occurred as a primary memory module and the other memory module as the secondary memory module. Readers will note that in other embodiments, the memory module on which the correctable memory error occurred may be utilized as the secondary memory module on which the memory contents are mirrored, while the other memory module may be utilized as the primary memory module.

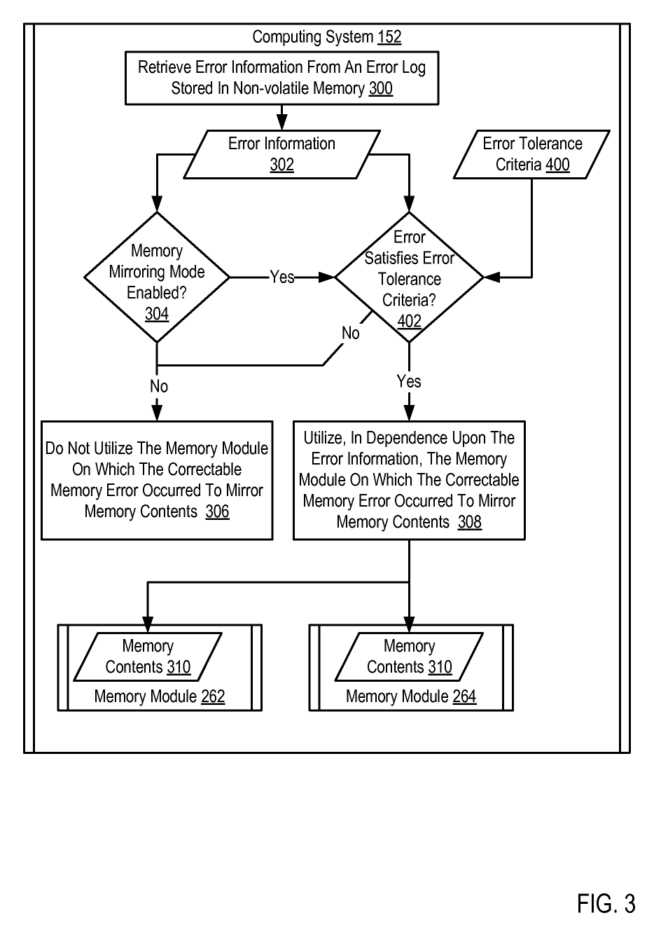

The description above with reference to FIG. 2 describes utilizing the memory module on which the correctable memory error occurred to mirror the memory contents if the memory mirroring mode is enabled for the computing system. In other embodiments, the memory module on which the correctable memory error occurred may be utilized to mirror the memory contents if the correctable memory error also satisfies error tolerance criteria. For further explanation, FIG. 3 sets forth a flow chart illustrating a further exemplary method for utilizing a potentially unreliable memory module for memory mirroring in a computing system according to embodiments of the present invention. In the example of FIG. 3, the computing system (152) includes at least two memory modules (262, 264).

The method of FIG. 3 is similar to the method of FIG. 2. That is, the method of FIG. 3 also includes: retrieving (300) error information (302) from an error log stored in non-volatile memory, the error information (302) describing an occurrence of a correctable memory error on one of the memory modules (262, 264); determining (304) whether a memory mirroring mode is enabled for the computing system, the memory mirroring mode specifying that memory contents (310) are mirrored on the two memory modules (262, 264); not utilizing (306) the memory module on which the correctable memory error occurred if the memory mirroring mode is not enabled; and utilizing (308), in dependence upon the error information (302), the memory module on which the correctable memory error occurred to mirror the memory contents (310) if the memory mirroring mode is enabled.

The method of FIG. 3 differs from the method of FIG. 2 in that the method of FIG. 3 includes determining (402) whether the correctable memory error satisfies error tolerance criteria (400). Error tolerance criteria (400) of FIG. 3 represent rules for determining whether a particular memory module on which correctable errors have occurred should be used for memory mirroring in the computing system (152). For example, error tolerance criteria may specify that a memory module on which more than ten correctable errors have occurred in over a twenty-four hour period should not be used, even for memory mirroring. Determining (402) whether the correctable memory error satisfies error tolerance criteria (400) according to the method of FIG. 3 may be carried out by identifying whether the error information (302) satisfies all of the rules specified by the error tolerance criteria (400). If the error information (302) satisfies all of the rules specified by the error tolerance criteria (400), then the correctable memory error satisfies error tolerance criteria (400). The correctable memory error does not satisfy error tolerance criteria (400), however, if the error information (302) does not satisfy all of the rules specified by the error tolerance criteria (400).

Utilizing (308), in dependence upon the error information (302), the memory module on which the correctable memory error occurred to mirror the memory contents (310) according to the method of FIG. 3 is carried out only if the memory mirroring mode is enabled and if the correctable memory error satisfies error tolerance criteria (400). If the memory mirroring mode is enabled and if the correctable memory error satisfies error tolerance criteria (400), utilizing (308) the memory module on which the correctable memory error occurred to mirror the memory contents (310) according to the method of FIG. 3 may be carried out in the manner described above with reference to FIG. 2.

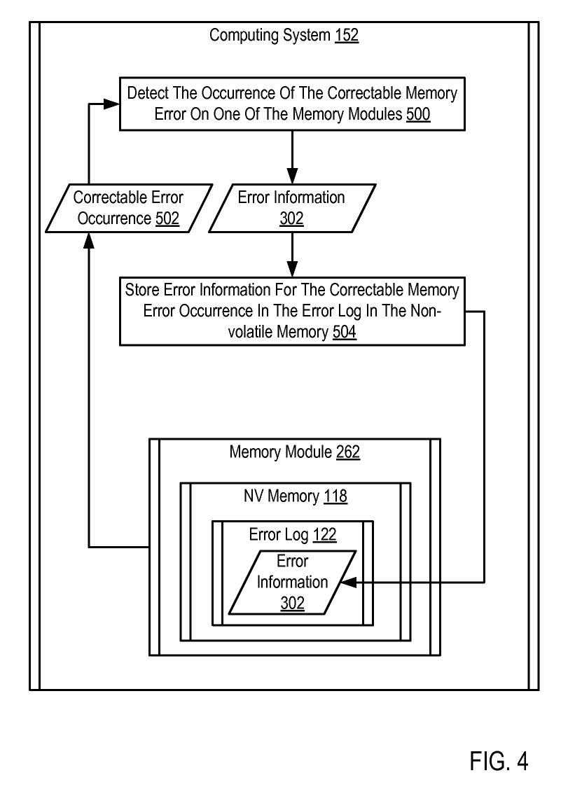

During operation of the computing system, a correctable memory error may occur on one of the memory modules. When such an error occurs, the computing system may record error information describing the error. For further explanation, therefore, FIG. 4 sets forth a flow chart illustrating a further exemplary method for utilizing a potentially unreliable memory module for memory mirroring in a computing system according to embodiments of the present invention.

The method of FIG. 4 includes detecting (500) the occurrence (502) of the correctable memory error on one of the memory modules (262). Detecting (500) the occurrence (502) of the correctable memory error on one of the memory modules (262) according to the method of FIG. 4 may be carried out by identifying an interrupt signal from the memory controller indicating that the memory controller's ECC circuitry corrected a memory error and retrieving error information (302) describing the correctable memory error occurrence (502) from registers in the memory controller.

The method of FIG. 4 also includes storing (504) the error information (302) for the correctable memory error occurrence (502) in the error log (122) in the non-volatile memory (118). Storing (504) the error information (302) for the correctable memory error occurrence (502) in the error log (122) in the non-volatile memory (118) according to the method of FIG. 4 may be carried out by storing the error information in the last 128 bytes of the SPD content contained in the non-volatile memory (118) configured on the memory module (262). Storing (504) the error information (302) for the correctable memory error occurrence (502) in the error log (122) allows the computing system to utilize the error information (302) in the future to provide users with updated error and reliability information, and to determine usability of the memory module for memory mirroring in a computing system utilizing the potentially unreliable memory module (262).

Exemplary embodiments of the present invention are described largely in the context of a fully functional computer system for utilizing a potentially unreliable memory module for memory mirroring in a computing system. Readers of skill in the art will recognize, however, that the present invention also may be embodied in a computer program product disposed on computer media for use with any suitable data processing system. Such computer readable media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of utilizing a potentially unreliable memory module for memory mirroring in a computing system, the computing system including at least two memory modules, the method comprising:
retrieving error information from an error log stored in non-volatile memory, the error information describing an occurrence of a correctable memory error on one of the memory modules;
determining whether a memory mirroring mode is enabled for the computing system, the memory mirroring mode specifying that memory contents are mirrored on the two memory modules; and
utilizing, in dependence upon the error information, the memory module on which the correctable memory error occurred to mirror the memory contents if the memory mirroring mode is enabled.

2. The method of claim 1 wherein utilizing, in dependence upon the error information, the memory module on which the correctable memory error occurred to mirror the memory contents further comprises:
utilizing the memory module on which the correctable memory error occurred as a primary memory module on which the memory contents are mirrored; and
utilizing the other memory module as a secondary memory module on which the memory contents are mirrored.

3. The method of claim 1 wherein utilizing, in dependence upon the error information, the memory module on which the correctable memory error occurred to mirror the memory contents further comprises:
utilizing the memory module on which the correctable memory error occurred as a secondary memory module on which the memory contents are mirrored; and
utilizing the other memory module as a primary memory module on which the memory contents are mirrored.

4. The method of claim 1 wherein:
the method further comprises determining whether the correctable memory error satisfies error tolerance criteria; and
utilizing, in dependence upon the error information, the memory module on which the correctable memory error occurred to mirror the memory contents further comprising utilizing the memory module on which the correctable memory error occurred to mirror the memory contents if the correctable memory error satisfies error tolerance criteria.

5. The method of claim 1 wherein the correctable memory error is a single-bit memory error.

6. The method of claim 1 further comprising:
detecting the occurrence of the correctable memory error on one of the memory modules; and
storing the error information for the correctable memory error occurrence in
the error log in the non-volatile memory.

7. A computing system for utilizing a potentially unreliable memory module for memory mirroring in the computing system, the computing system including at least two memory modules, the computer comprising a computer processor operatively coupled to computer memory, the computer memory having disposed within it computer program instructions capable of:
retrieving error information from an error log stored in non-volatile memory, the error information describing an occurrence of a correctable memory error on one of the memory modules;
determining whether a memory mirroring mode is enabled for the computing system, the memory mirroring mode specifying that memory contents are mirrored on the two memory modules; and
utilizing, in dependence upon the error information, the memory module on which the correctable memory error occurred to mirror the memory contents if the memory mirroring mode is enabled.

8. The computing system of claim 7 wherein utilizing, in dependence upon the error information, the memory module on which the correctable memory error occurred to mirror the memory contents further comprises:
utilizing the memory module on which the correctable memory error occurred as a primary memory module on which the memory contents are mirrored; and
utilizing the other memory module as a secondary memory module on which the memory contents are mirrored.

9. The computing system of claim 7 wherein utilizing, in dependence upon the error information, the memory module on which the correctable memory error occurred to mirror the memory contents further comprises:
utilizing the memory module on which the correctable memory error occurred as a secondary memory module on which the memory contents are mirrored; and
utilizing the other memory module as a primary memory module on which the memory contents are mirrored.

10. The computing system of claim 7 wherein:
the computer memory has disposed within it computer program instructions capable of determining whether the correctable memory error satisfies error tolerance criteria; and
utilizing, in dependence upon the error information, the memory module on which the correctable memory error occurred to mirror the memory contents further comprising utilizing the memory module on which the correctable memory error occurred to mirror the memory contents if the correctable memory error satisfies error tolerance criteria.

11. The computing system of claim 7 wherein the correctable memory error is a single-bit memory error.

12. The computing system of claim 7 wherein the computer memory has disposed within it computer program instructions capable of:
detecting the occurrence of the correctable memory error on one of the memory modules; and
storing the error information for the correctable memory error occurrence in the error log in the non-volatile memory.

13. A computer program product for utilizing a potentially unreliable memory module for memory mirroring in a computing system, the computing system including at least two memory modules, the computer program product disposed in a computer readable medium, the computer program product comprising computer program instructions capable of:
retrieving error information from an error log stored in non-volatile memory, the error information describing an occurrence of a correctable memory error on one of the memory modules;
determining whether a memory mirroring mode is enabled for the computing system, the memory mirroring mode specifying that memory contents are mirrored on the two memory modules; and
utilizing, in dependence upon the error information, the memory module on which the correctable memory error occurred to mirror the memory contents if the memory mirroring mode is enabled.

14. The computer program product of claim 13 wherein utilizing, in dependence upon the error information, the memory module on which the correctable memory error occurred to mirror the memory contents further comprises:
utilizing the memory module on which the correctable memory error occurred as a primary memory module on which the memory contents are mirrored; and
utilizing the other memory module as a secondary memory module on which the memory contents are mirrored.

15. The computer program product of claim 13 wherein utilizing, in dependence upon the error information, the memory module on which the correctable memory error occurred to mirror the memory contents further comprises:
utilizing the memory module on which the correctable memory error occurred as a secondary memory module on which the memory contents are mirrored; and
utilizing the other memory module as a primary memory module on which the memory contents are mirrored.

16. The computer program product of claim 13 wherein:
the computer program product further comprises computer program instructions capable of determining whether the correctable memory error satisfies error tolerance criteria; and
utilizing, in dependence upon the error information, the memory module on which the correctable memory error occurred to mirror the memory contents further comprising utilizing the memory module on which the correctable memory error occurred to mirror the memory contents if the correctable memory error satisfies error tolerance criteria.

17. The computer program product of claim 13 wherein the correctable memory error is a single-bit memory error.

18. The computer program product of claim 13 further comprising computer program instructions capable of:
detecting the occurrence of the correctable memory error on one of the memory modules; and
storing the error information for the correctable memory error occurrence in the error log in the non-volatile memory.

19. The computer program product of claim 13 wherein the computer readable medium comprises a recordable medium.

20. The computer program product of claim 13 wherein the computer readable medium comprises a transmission medium.
